(19) United States
(12) Patent Application Publication
(10) Pub. No.: US 2025/0236371 A1
(43) Pub. Date: Jul. 24, 2025

(54) BIONIC RESCUE ROBOT FISH

(71) Applicant: Dongguan University of Technology, Dongguan (CN)

(72) Inventors: Jialei SONG, Dongguan (CN); Yang XIAO, Dongguan (CN); Ling YIN, Dongguan (CN)

(21) Appl. No.: 18/894,395

(22) Filed: Sep. 24, 2024

(30) Foreign Application Priority Data
Jan. 23, 2024 (CN) 202410088756.X

(51) Int. Cl. B63C 9/23; B25J 11/00; B63C 9/00; B63H 1/36

(52) U.S. Cl. CPC B63C 9/23; B25J 11/00; B63H 1/36; B63C 2009/0035

(57) ABSTRACT

Provided is a bionic rescue robot fish, including a fish body skeleton, a fish head skeleton, a fishtail swing mechanism, a pectoral fin swing mechanism, a rescue mechanism and a buoyancy adjusting mechanism. The fish body skeleton is movably connected to the fish head skeleton. The fishtail swing mechanism, the pectoral fin swing mechanism, the rescue mechanism and the buoyancy adjusting mechanism are arranged on the fish head skeleton. Bionic fish skin is attached to surfaces of the fish body skeleton and the fish head skeleton in a sealing manner. The fishtail swing mechanism, the pectoral fin swing mechanism, the rescue mechanism and the buoyancy adjusting mechanism are each communicated with a control unit. The rescue mechanism can release a lifesaving airbag, and the buoyancy adjusting mechanism can change the volume of fish belly part.

### CROSS-REFERENCE TO RELATED APPLICATION

This patent application claims the benefit and priority of Chinese Patent Application No. 202410088756X filed with the China National Intellectual Property Administration on Jan. 23, 2024, the disclosure of which is incorporated by reference herein in its entirety as part of the present application.

### TECHNICAL FIELD

The present disclosure relates to the technical field of bionic fish, in particular to a bionic rescue robot fish.

### BACKGROUND

As early as the 19th century, popular research directions have emerged in the field of underwater robots, such as AUV (Autonomous Underwater Vehicle) and ROV (Remotely Operated Vehicle). However, with the research of fish swimming mechanism, it is found that these traditional underwater robots have obvious shortcomings. Most of these traditional underwater robots are in the form of propeller propulsion, which often have the disadvantages of loud noise, complex control system, huge volume and low propulsion efficiency. Therefore, based on the fish swimming mechanism, people combine the biological principle of the fish with mechanical control, and put forward an underwater robot-bionic robot fish based on bionics principle.

The common snorkeling methods of existing bionic robot fish are a pectoral fin method, a shape change method, a water storage compartment method and a method of changing the center of gravity. The pectoral fin method is to change the direction of fluid thrust by using the swing of the pectoral fin, thus achieving floating and diving. The shape change method is to change the volume of the bionic robot fish itself, thus changing the buoyancy and completing the floating and diving movements. The water storage compartment method is to change the self-weight of the bionic robot fish, thus completing the floating and diving movements. The method of changing the center of gravity is to change a pitch angle of the head of the bionic robot fish by using the deviation of the center of gravity, thus completing the floating and diving movements.

At present, most bionic robot fish on the market are mainly actuated by multiple joint steering gears in series to fit a wave curve of the fish body, that is, one steering gear drives one joint, and the swing amplitude of the fish body is controlled by driving the rotation angle of each steering gear, thus simulating the body fluctuation of real fish. According to this method, the bionic robot fish is close to the fish swimming posture to some extent, but this method requires high synchronization of driving motors, and with the increase of the number of joints, the number of driving motors also increases, which often leads to more and more complicated control structure and increased power consumption. In addition, in some bionic robot fish, hydraulic (pneumatic) drive is used to control the swing of the fish body. This bionic robot fish needs to establish a complete hydraulic (pneumatic) driving system, and the hydraulic (pneumatic) valve and electronic directional valve are used to control the movement of the piston in the hydraulic (pneumatic) cylinder to achieve the motion control of the robot fish. Such a robot fish has the characteristics of large torque and accurate control process, but the whole drive system is particularly complicated.

Submerged structures, such as offshore drilling platforms and bridges, are easily eroded by seawater, so that the building structure is damaged. Meanwhile, because there are few data sets about the submerged structure, the results trained by most neural networks are not ideal. At present, the underwater robots are mainly ROV and AUV robots propelled by propellers, which have the disadvantages of low efficiency, inflexibility and huge volume. In the experimental observation of fish swimming, it is found that the swimming mode of fish has high propulsion efficiency and the fish has high flexibility. The traditional motor-actuated bionic robot fish is mainly actuated by multiple joints in series, that is, one joint is actuated by one motor, but with the increase of the number of joints, the number of motors also increases. Although this driving mode makes the fluctuation of the fishtail close to a fluctuation curve of the fish body, the control difficulty is increased.

Secondly, the existing bionic robot fish are mostly used in experimental testing, water quality testing, fish school testing, underwater pipeline testing and other fields, and the use scenarios are limited.

Furthermore, in order to realize the floating and diving of the bionic robot fish, people have designed many schemes to realize this function, among which the common methods are the water storage compartment method, the pectoral fin control method, the method for changing the position of the center of gravity and so on, but these methods have some shortcomings more or less. The pectoral fin control method cannot completely simulate the fish in function, and is poor in real-time performance, lack of mobility and difficulty in dynamic sealing and waterproofing. The water storage compartment method needs to occupy a large space and when the bionic robot fish reaches a certain depth, the action of water suction and drainage is affected by water pressure, and the efficiency of pumping and drainage by using a lead screw push rod is relatively low. The method of charging the center of gravity takes up a large internal space and has little effect. In addition, there are few pictures about submerged structure and the underwater victims, and the model effect of visual processing network training processing is not ideal.

### SUMMARY

An objective of the present disclosure is to provide a bionic rescue robot fish to solve the problems in the prior art, thus improving the maneuverability of the robot fish, and making the robot fish have a rescue function.

To achieve the objective above, the present disclosure employs the following technical solutions.

The present disclosure provides a bionic rescue robot fish, including a fish body skeleton, a fish head skeleton, a fishtail swing mechanism, a pectoral fin swing mechanism, a rescue mechanism and a buoyancy adjusting mechanism. The fish body skeleton is movably connected to the fish head skeleton. The fishtail swing mechanism, the pectoral fin swing mechanism, the rescue mechanism and the buoyancy adjusting mechanism are arranged on the fish head skeleton. Bionic fish skin is attached to surfaces of the fish body skeleton and the fish head skeleton in a sealing manner. The fishtail swing mechanism, the pectoral fin swing mechanism, the rescue mechanism and the buoyancy adjusting mechanism are each in communication with a control unit. The rescue mechanism is configured to release a lifesaving airbag, and the buoyancy adjusting mechanism is configured to change a volume of a fish belly part of the bionic rescue robot fish.

Preferably, the fish body skeleton includes multiple profiling support pieces, and outer contour dimensions of the multiple profiling support pieces are designed according to an overall dimension of fish, and gradually increase along a direction from a tail of the bionic rescue robot fish to a head of the bionic rescue robot fish. One or a pair of hinge lugs are arranged at a middle part of each of the multiple profiling support pieces, and adjacent profiling support pieces of the multiple profiling support pieces are hinged with a pin shaft through the hinge lugs. A flexible tail fin is connected to a smallest one of the multiple profiling support pieces. A biggest one of the multiple profiling support pieces is hinged with the hinge lugs on the fish head skeleton, and the bionic fish skin is attached to the smallest one of the multiple profiling support pieces and an outside of an end of the fish head skeleton in a sealing manner, so as to form a bionic fish body.

Preferably, a resilient sheet is fixedly connected between the adjacent profiling support pieces. The bionic fish skin is of a bellow structure, the multiple profiling support pieces are elliptical, and lower parts of the multiple profiling support pieces are respectively provided with counterweights. A shape of each of the counterweights is symmetrical about a long axis of a corresponding one of the multiple profiling support pieces, and a center of gravity of the counterweight is adjacent to a middle part of the fish body.

Preferably, the fishtail swing mechanism includes a stepping motor, a gear transmission mechanism, pull wires and two pull wire drums. The two pull wire drums are connected to a rotating shaft of the gear transmission mechanism, and the two pull wire drums are symmetrically arranged up and down in a manner perpendicular to the flexible tail fin. Both sides of each of the two pull wire drums are fixedly connected to corresponding positions of the smallest one of the multiple profiling support pieces by the pull wires, and the stepping motor is connected to the gear transmission mechanism.

Preferably, a transparent observation window of a pressure-resistance glass cover is arranged on an upper part of the fish head skeleton in a sealing manner. A color camera is connected to a support inside the observation window. A sealing ring is arranged between the observation window and the fish head skeleton. The fish head skeleton is provided with a sealing compartment and a battery compartment. The control unit is arranged in the sealing compartment, and a storage battery is arranged in the battery compartment. A top of the fish head skeleton is provided with a power switch, and both sides and a front end of the fish head skeleton is provided with an ultrasonic sensor.

Preferably, the pectoral fin swing mechanism is symmetrically arranged in the fish head skeleton, and includes two waterproof steering gears, two gear transmission mechanisms and pectoral fins. Each of the two waterproof steering gears is connected to a corresponding one of the two gear transmission mechanisms, and a rotating shaft of one gear of each of the two gear transmission mechanisms is connected to a corresponding one of the pectoral fins by a coupling. The coupling is rotatably arranged in a through groove of a special-shaped waterproof block, and an inside of the waterproof block is connected to a flange on the rotating shaft of the gear through a double-lip sealing ring. The two waterproof steering gears are configured to make the pectoral fins swing up and down by 30°-50° with a horizontal plane as a middle plane.

Preferably, the fish belly part of the fish head skeleton is provided with a U-shaped groove, and the rescue mechanism and the buoyancy adjusting mechanism are arranged in the U-shaped groove. The bionic fish skin is attached to two side walls of the buoyancy adjusting mechanism, two side walls of the U-shaped groove and a bottom of the rescue mechanism in a sealing manner. The bionic fish skin is resilient, and the buoyancy adjusting mechanism is configured to change a volume of the bionic fish skin.

Preferably, a shape of the rescue mechanism is U-shaped, and the rescue mechanism includes a base, an upper cover, a waterproof steering gear, a bevel gear transmission mechanism, hatch door opening mechanisms, gas cylinder opening mechanisms, lifesaving airbags and gas cylinders. The base is connected to the upper cover by a bolt in a sealing manner. The waterproof steering gear of the rescue mechanism is respectively connected to the hatch door opening mechanisms and the gas cylinder opening mechanisms on both sides of the rescue mechanism through the bevel gear transmission mechanism. Rescue capsules are symmetrically hinged to both sides of the base, and the hatch door opening mechanism are respectively provided on the rescue capsules. The lifesaving airbags which are folded and respectively arranged in the rescue capsules in a sealing manner, and the gas cylinders are respectively arranged in the rescue capsules in a sealing manner. A gas outlet pipe of each of the gas cylinders is connected to a gas inlet nozzle of a corresponding one of the rescue capsules and an ejector pin by a tee. The ejector pin is configured to open a gas outlet channel communicating between a corresponding one of the gas cylinders and a corresponding one of the lifesaving airbags through a corresponding one of the gas cylinder opening mechanisms.

Preferably, each of the hatch door opening mechanisms includes a transmission gear and a wobble gear where the wobble gear is fixedly connected to a hinge shaft of the hatch door and meshed with the transmission gear. The transmission gear and one bevel gear of the bevel gear transmission mechanism are coaxially arranged. Each of the gas cylinder opening mechanisms includes a spur gear and a rack. The spur gear and the wobble gear are coaxially arranged, the rack is meshed with the spur gear, and the rack is slidably arranged in a sliding chute of the upper cover. The rack is provided with a bump with an inclination angle, and the bump is configured to extrude the ejector pin to move axially to open the gas outlet channel. A protective sleeve is connected to an outside of the gas cylinder through threads, and includes a head protective sleeve and a tail protective sleeve which are spliced into a whole. The head protective sleeve is provided with a limit hole for the ejector pin.

Preferably, the buoyancy adjusting mechanism includes a waterproof housing, a waterproof steering gear, a variable diameter mechanism and multiple profiling push plates. The multiple profiling push plates are able to be spliced into the fish belly part with an U shape. The waterproof housing is arranged inside the fish belly part, and the waterproof steering gear and the variable diameter mechanism are arranged in the waterproof housing. The waterproof steering gear of the buoyancy adjusting mechanism is connected to the variable diameter mechanism and the multiple profiling push plates through the variable diameter mechanism. The multiple profiling push plates are wrapped with the bionic fish skin and are configured to extend outwards and retract inwards through the variable diameter mechanism.

Preferably, the variable diameter mechanism includes a variable diameter rotating disc and a gear transmission mechanism. The waterproof steering gear of the buoyancy adjusting mechanism is connected to the variable diameter rotating disc by the gear transmission mechanism, and each of the multiple profiling push plates is provided with a support rod. A middle part of the variable diameter rotating disc is provided with multiple arc waist-shaped holes, inner ends of the multiple waist-shaped holes are located in a same smaller radius concentric circle, outer ends of the multiple waist-shaped holes are located in a same larger radius concentric circle, and one waist-shaped holes corresponds to one support rod. A tail end of each support rod is slidably arranged in a corresponding one of the multiple waist-shaped holes through a pin shaft, and the waterproof housing is provided with a guide groove, and the support rod movably penetrates through the guide groove.

Compared with the prior art, some embodiments have the following technical effects:

The present disclosure provides a novel bionic robot fish mainly based on the propulsion mode of the Carangidae, which can simulate the swimming of fish more realistically through a driving mode of the swinging of fishtail and pectoral fin, thus achieving higher propulsion efficiency and flexibility. A rescue mechanism and a buoyancy adjusting mechanism are added on the structure, which can be used for underwater rescue. The buoyancy adjusting mechanism can simulate the action mechanism of a real swim bladder, and change a relationship between the gravity and buoyancy of the bionic robot fish, thus achieving the functions of floating and diving.

### BRIEF DESCRIPTION OF THE DRAWINGS

In order to illustrate the embodiments of the present disclosure or the technical solutions in the prior art more clearly, the drawings needed in the embodiments will be briefly introduced hereinafter. Apparently, the drawings in the following description are only some embodiments of the present disclosure. For those skilled in the art, other drawings can be obtained according to these drawings without paying creative labor.

FIG. 1 is a schematic diagram of an appearance configuration of a bionic rescue robot fish according to an embodiment of the present disclosure;

FIG. 2 is a schematic diagram of an internal structure of a bionic rescue robot fish according to an embodiment of the present disclosure;

FIG. 3 is a first structural schematic diagram of a fish body skeleton and a fishtail swing mechanism according to an embodiment of the present disclosure;

FIG. 4 is a second structural schematic diagram of a fish body skeleton and a fishtail swing mechanism according to an embodiment of the present disclosure;

FIG. 5 is a third structural schematic diagram of a fish body skeleton and a fishtail swing mechanism according to an embodiment of the present disclosure;

FIG. 6 is a first structural schematic diagram of a fish head skeleton according to an embodiment of the present disclosure;

FIG. 7 is a second structural schematic diagram of a fish head skeleton according to an embodiment of the present disclosure;

FIG. 8 is a schematic diagram of a pectoral fin swing mechanism shown in FIG. 7 according to an embodiment of the present disclosure;

FIG. 9 is a schematic diagram of a rescue mechanism according to an embodiment of the present disclosure;

FIG. 10 is a first structural schematic diagram of a buoyancy adjusting mechanism according to an embodiment of the present disclosure;

FIG. 11 is a second structural schematic diagram of a buoyancy adjusting mechanism according to an embodiment of the present disclosure;

FIG. 12 is a third structural schematic diagram of a buoyancy adjusting mechanism according to an embodiment of the present disclosure;

FIG. 13 is a structural schematic diagram of a variable diameter rotating disc according to an embodiment of the present disclosure.

In the drawings: 1 fish body skeleton; 2 fish head skeleton; 3 fishtail swing mechanism; 4 pectoral fin swing mechanism; 5 rescue mechanism; 6 buoyancy adjusting mechanism; 7 profiling support piece; 8 hinge lug; 9 flexible tail fin; 10 counterweight; 11 stepping motor; 12 gear transmission mechanism; 13 pull wire drum; 14 pull wire; 15 bionic fish skin; 16 observation window; 17 color camera; 18 control unit; 19 resilient sheet; 20 ultrasonic sensor; 21 waterproof steering gear; 22 coupling; 23 pectoral fin; 24 waterproof block; 25 flange; 26 sealing ring; 27 bearing; 28 base; 29 bevel gear transmission mechanism; 30 hatch door; 31 lifesaving airbag; 32 gas inlet nozzle; 33 gas cylinder; 34 ejector pin; 35 transmission gear; 36 wobble gear; 37 spur gear; 38 rack; 39 bump; 40 protective sleeve; 41 waterproof housing; 42 profiling push plate; 43 support rod; 44 variable diameter rotating disc; 45 waist-shaped hole; 46 pin shaft; 47 storage battery; 48 power switch.

### DETAILED DESCRIPTION OF THE EMBODIMENTS

The technical solutions in the embodiments of the present disclosure will be described clearly and completely hereinafter with reference to the drawings of the embodiments of the present disclosure. Apparently, the described embodiments are some embodiments of the present disclosure, rather than all of the embodiments. Based on the embodiments of the present disclosure, all other embodiments obtained by those skilled in the art without paying creative labor fall in the scope of protection of the present disclosure.

An objective of the present disclosure is to provide a bionic rescue robot fish to solve the problems in the prior art, thus improving the maneuverability of the robot fish, and making the robot fish have a rescue function.

In order to make the above objects, features and advantages of the present disclosure more obvious and understandable, the present disclosure will be further explained in detail hereinafter with reference to the drawings and specific embodiments.

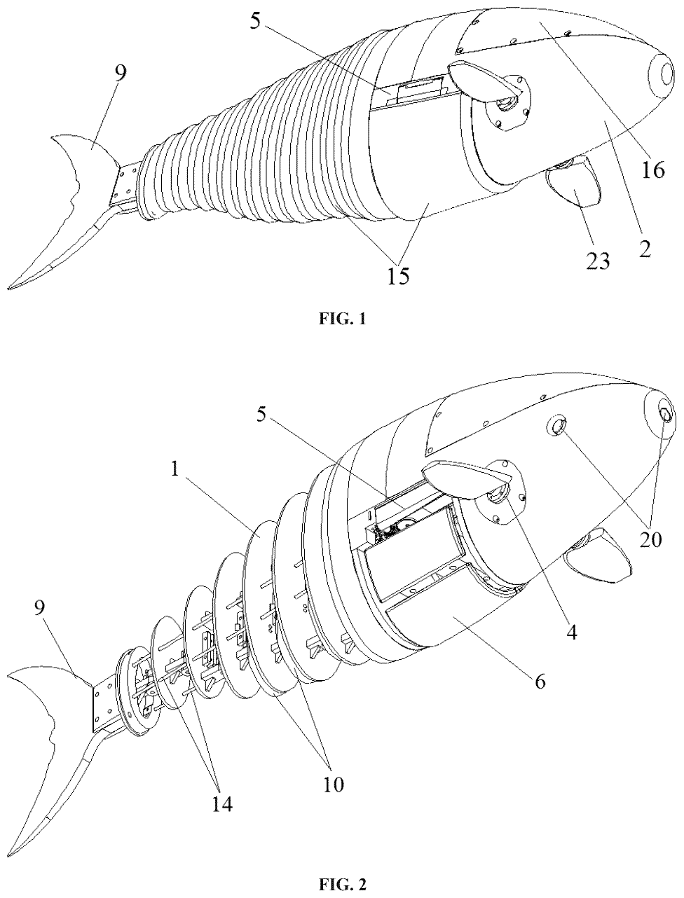

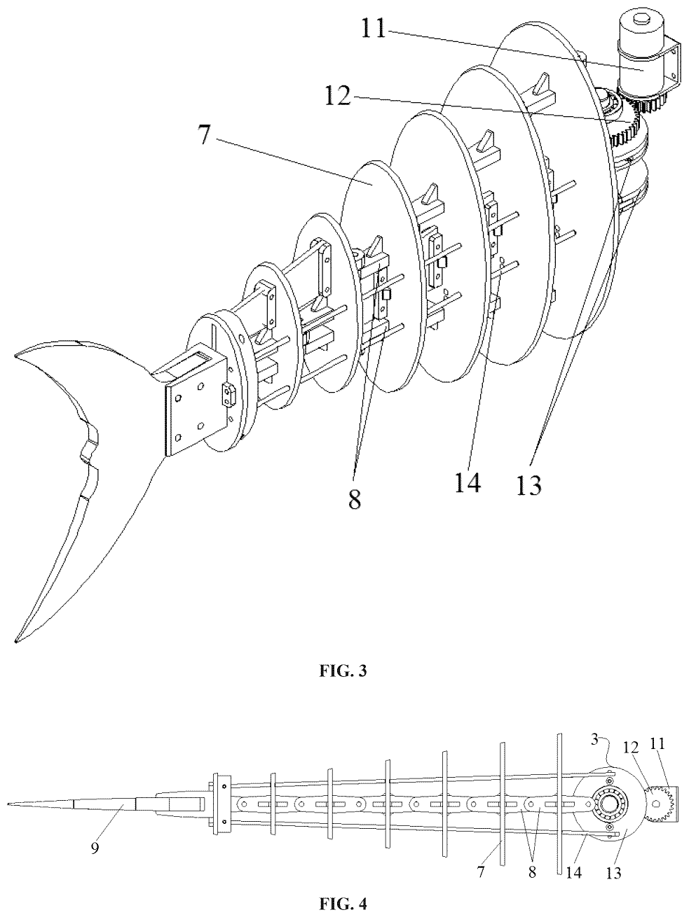

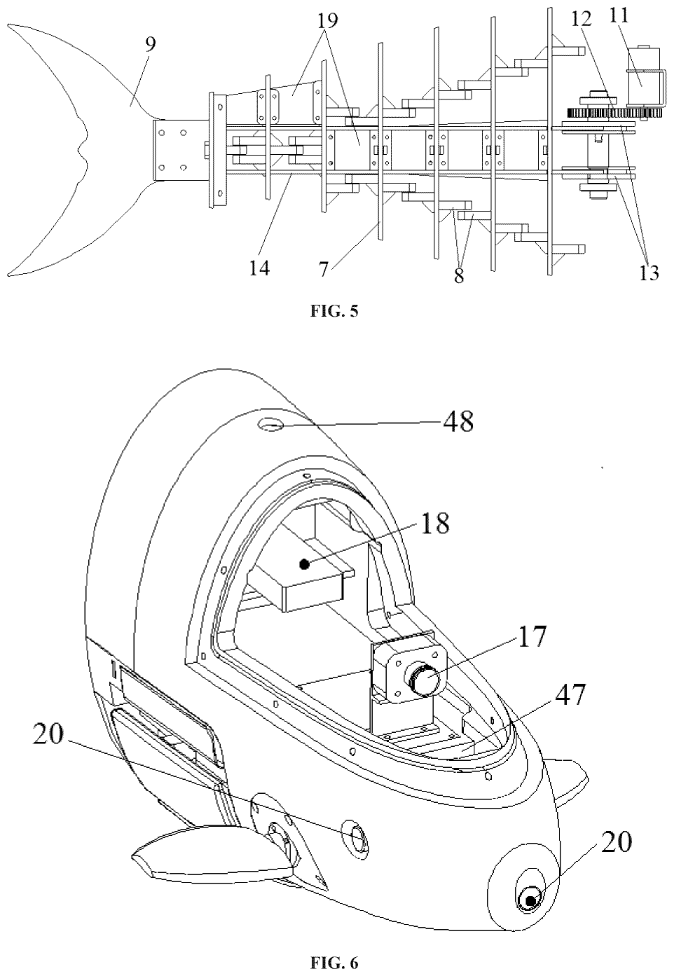

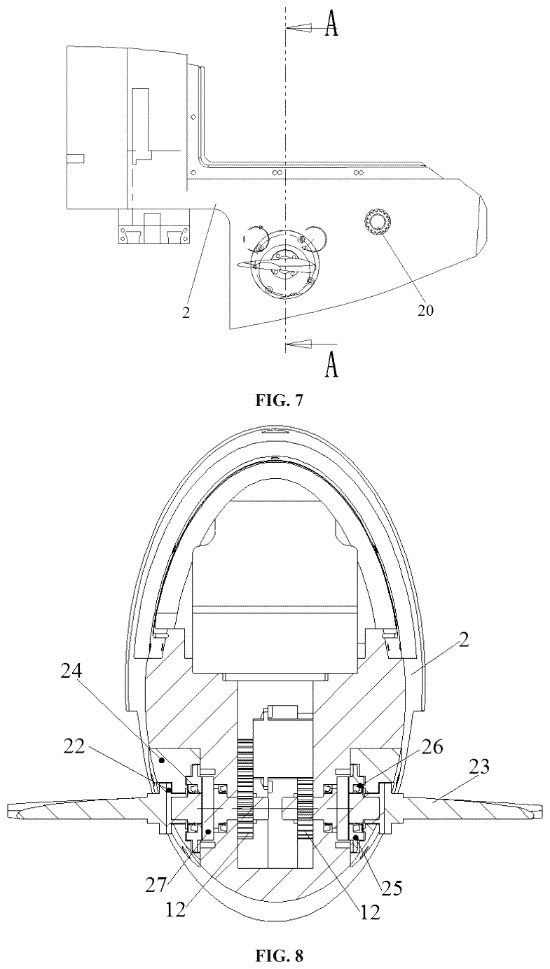

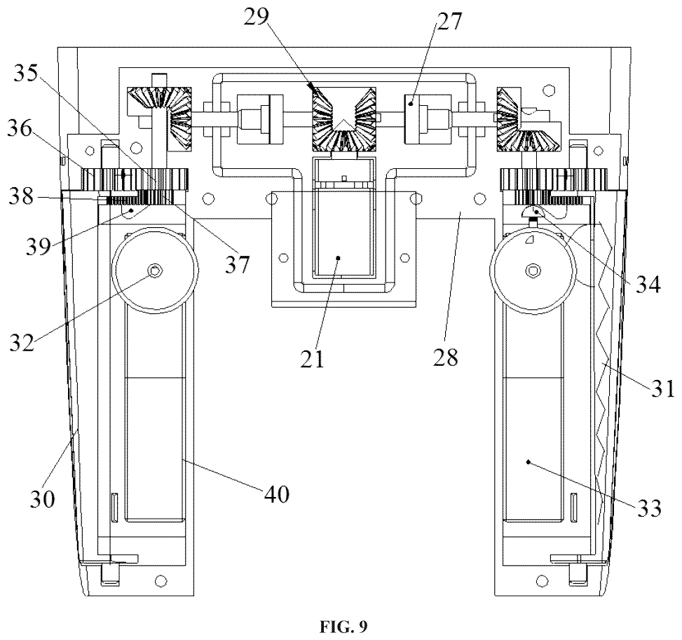

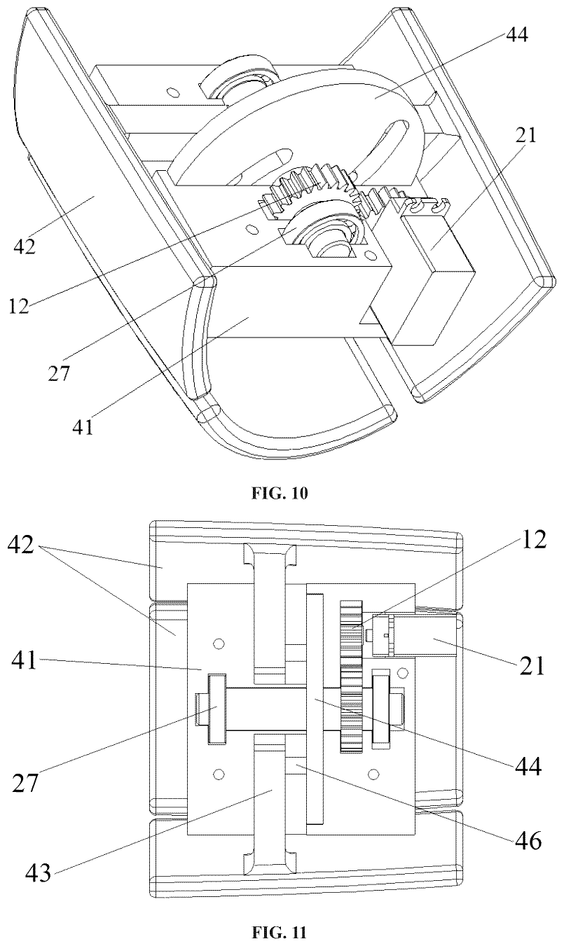

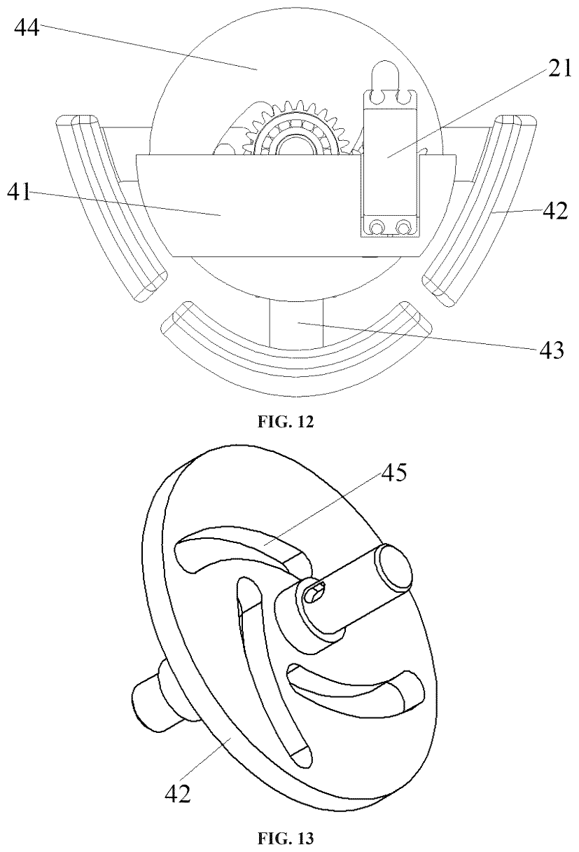

As shown in FIG. 1 to FIG. 13, this embodiment provides a bionic rescue robot fish, including a fish body skeleton 1, a fish head skeleton 2, a fishtail swing mechanism 3, a pectoral fin swing mechanism 4, a rescue mechanism 5, and a buoyancy adjusting mechanism 6. The fish body skeleton 1 is movably connected to the fish head skeleton 2. The fishtail swing mechanism 3, the pectoral fin swing mechanism 4, the rescue mechanism 5 and the buoyancy adjusting mechanism 5 are arranged on the fish head skeleton 2. Bionic fish skin 15 is attached to the surfaces of the fish body skeleton 1 and the fish head skeleton 2 in a sealing manner. The fishtail swing mechanism 3, the pectoral fin swing mechanism 4, the rescue mechanism 5 and the buoyancy adjusting mechanism 6 are each communicated with a control unit 18. The rescue mechanism 5 can release a lifesaving airbag 31, and the buoyancy adjusting mechanism 6 can change the volume of fish belly part. Each module or mechanism in this embodiment adopts modular design, and has relevant waterproof arrangement separately, thus reducing the possibility of water ingress of electronic components, and making the rest operate normally when a part leaks water.

As an alternative scheme, the fish body skeleton 1 in this embodiment includes multiple profiling support pieces 7, and outer contour dimensions of the profiling support pieces 7 are designed according to an overall dimension of fish, and gradually increase along a direction from a tail to a head. One or a pair of hinge lugs 8 are arranged at the middle of each profiling support piece 7, and adjacent profiling support pieces 7 are hinged with a pin shaft 46 through the hinge lugs 8. A flexible tail fin 9 is connected to the smallest profiling support piece 7. The biggest profiling support piece 7 is hinged with the hinge lug 8 on the fish head skeleton 2, and the bionic fish skin 15 is attached to the smallest profiling support piece 7 and the outside of an end of the fish head skeleton 2 in a sealing manner, so as to form a bionic fish body. A resilient sheet 19 is fixedly connected between the adjacent profiling support pieces 7, and mounting grooves are formed in both sides of the profiling support pieces 7. The resilient sheet 19 is fixedly mounted by the bolt after being inserted into the mounting groove, with the main function of limiting the degree of freedom of a rotating joint. In the process of dragging the pull wire 14, various joints can simultaneously swing towards one side, thus controlling the swing form of the fishtail to be consistent with the designed form conveniently. The bionic fish skin 15 at the fishtail is of a bellow structure, which is better suitable for the swing deformation of the fishtail. The profiling support piece 7 is elliptical and provided with a counterweight 10 at the lower part thereof, the shape of the counterweight 10 is symmetrical about a long axis of the profiling support piece 7, and the center of gravity of the counterweight 10 is adjacent to the middle part of the fish body, which is convenient for keeping the balance of the fish. In this embodiment, a fan-shaped carbon steel material is added in the middle part of the flexible tail fin 9, such that the flexible tail fin 9 has a certain resilience and rigidity and is not easy to be damaged.

As an alternative scheme, the fishtail swing mechanism 3 in this embodiment includes a stepping motor 11, a gear transmission mechanism 12, pull wires 14 and pull wire drums 13. The pull wire drums 13 are connected to a rotating shaft of the gear transmission mechanism 12, and two pull wire drums 13 are symmetrically arranged up and down in a manner of perpendicular to the flexible tail fin 9. Both sides of each pull wire drum 13 penetrate intermediate profiling support pieces 7 in the middle in turn through the pull wires 14 and are fixedly connected to corresponding positions of the smallest profiling support piece 7. The stepping motor 11 is connected to the gear transmission mechanism 12. In this embodiment, six intermediate profiling support pieces 7 are connected in turn by hinges from beginning to end, and the stepping motor 11 is preferably a stepping deceleration motor. In order to reduce friction, a copper sleeve is arranged between the pull wire 14 and the profiling support piece 7. In order to balance the mass of the system, a counterweight 10 with a certain mass is preferably arranged at a middle lower part of each of the first three profiling support pieces 7 which is adjacent to the head skeleton. In this embodiment, the fishtail swing mechanism 3 is actuated by a motor to drive the pull wires 14 on both sides, thus achieving the fluctuation of the fishtail, which not only reduces the number of motors and greatly simplifies the control difficulty, but also can more truly simulate the swimming of fish, thus obtaining higher propulsion efficiency and flexibility. In this embodiment, the inspiration is drawn from creatures such as octopus and snake, which have body movements controlled by symmetrical muscle groups. For example, when the tentacles of the octopus bend leftwards, the left muscle group contracts and the right muscle group relaxes, and the body fluctuation of the fish is also controlled by the muscle groups on both sides of the body skeleton. Therefore, in this embodiment, a pair of pull wires 14 is configured to simulate the muscle groups on both sides of the body skeleton of the fish, and the muscular contraction and relaxation are simulated by changing the lengths of the pull wires 14 on both sides. In this underactuated pull wire mechanism, one motor is configured to actuate a pair of high-toughness pull wires 14, which greatly reduces the control difficulty and increases the flexibility of the mechanical structure. In this embodiment, an underactuated pull wire mechanism based on CPG (Central Pattern Generator) control is adopted, which can reduce the use of motors to a certain extent, and meanwhile, this way can better fit the fluctuation curve of fish and improve the propulsion efficiency.

Preferably, a transparent observation window 16 is arranged on an upper part of the fish head skeleton 2 in a sealing manner, a color camera 17 is connected to a support inside the observation window 16, the observation window 16 is a pressure-resistant glass cover, and a sealing ring 26 is arranged between the observation window 16 and the fish head skeleton 2. The fish head skeleton 2 is provided with a sealing compartment and a battery compartment. The control unit 18 is arranged in the sealing compartment, and a storage battery 47 is arranged in the battery compartment. The top of the fish head skeleton 2 is provided with a power switch 48, and both sides and a front end of the fish head skeleton is provided with an ultrasonic sensor 20. The ultrasonic sensor 20 can improve the perception of the robot fish to the surrounding environment. The ultrasonic sensor 20 is configured to detect whether there are obstacles around the robot fish or not, and in combination with an obstacle avoidance algorithm, the robot fish can avoid obstacles and is prevented from colliding with obstacles. The power switch 48 is exposed, so a waterproof switch is employed. In this embodiment, a platform is loaded with a high-resolution color camera 17 (RGB), which can collect a certain number of photos and other related pictures of the submerged structure which is eroded in different degrees for neural network training of the bionic fish. After a certain number of training iterations, a neural network training model can efficiently and accurately identify the defects of the submerged structure and underwater victims, thus reducing unnecessary troubles for subsequent maintenance personnel to deal with the defects of the submerged structure, and enabling the bionic robot fish to autonomously rescue underwater victims independently. Among many training models, the training conditions of different models are compared to choose the YOLOv8 model with more accurate recognition, more pro-quantization and faster recognition speed as the neural training network model, which can meet the demands of different scenarios and support the tasks of image classification, target detection, instance segmentation and gesture detection. A fish head sealed cabin is mainly configured for storing a control board, a motor control board, a wire, and other electronic components. In this embodiment, the observation window 16 and the fish head skeleton 2 are configured to form a sealed cabin, and a connecting part of the fish head skeleton 2 and the observation window 16 is additionally coated with waterproof sealant, thus preventing the water from entering the electronic component and sealing the control unit 18 and a motor drive board. In addition, the junction of the electric wires is also sealed by glue filling of a waterproof wiring terminal.

As an alternative scheme, the pectoral fin swing mechanism 4 is symmetrically arranged in the fish head skeleton 2, and includes two waterproof steering gears 21, two gear transmission mechanisms 12, and pectoral fins 23. Each waterproof steering gear 21 is connected to a corresponding one of the gear transmission mechanisms 12, and a rotating shaft of one gear of each gear transmission mechanism 12 is connected to the pectoral fin 23 by a coupling 22. The coupling 22 is preferably a double-lip sealing ring, and rotatably arranged in a through groove of a special-shaped waterproof block 24, and the inside of the waterproof block 24 is connected to a flange 25 on the rotating shaft of the gear through the sealing ring 26. The waterproof block 24 is located in a fish head housing to guarantee that the whole pectoral fin swing mechanism 4 is statically sealed. The water steering gear 21 can make the pectoral fin 23 swing up and down by 30°-50° with a horizontal plane as the middle plane. Biological research shows that the rhythmic swimming of fish is controlled by a local oscillating neural network-central pattern generator (CPG) composed of central neurons in the body. Self-excited oscillation is achieved through mutual inhibition between the neurons, and a stable periodic signal is generated, thus achieving the rhythmic movement control of limbs or body-related parts. In this embodiment, a GPG control-based mode is adopted to actuate a tail fin swing mechanism and the pectoral fin swing mechanism 4 at both sides of the fish body to generate rhythmic movement. In this embodiment, a set of multi-fin operating systems is designed, which is divided into the tail fin and the pectoral fin 23, and can increase the stability of the bionic robot fish to a certain extent.

As an alternative scheme, a fish belly part of the fish head skeleton 2 in this embodiment is provided with a U-shaped groove, and the rescue mechanism 5 and the buoyancy adjusting mechanism 6 are arranged in the U-shaped groove in turn. The bionic fish skin is attached to the two side walls of the buoyancy adjusting mechanism 6, two side walls of the U-shaped groove and the bottom of the rescue mechanism 5 in a sealing manner. The bionic fish skin 15 at the fish belly part is made of a smooth and resilient material, and the buoyancy adjusting mechanism 6 configured to change a volume of the bionic fish skin 15.

As an alternative scheme, a shape of the rescue mechanism 5 in this embodiment is U-shaped, and the rescue mechanism 5 includes a base 28, an upper cover, a waterproof steering gear 24, a bevel gear transmission mechanism 29, a hatch door opening mechanism, a gas cylinder opening mechanism, a life-saving airbag 31 and a gas cylinder 33. The base 28 is connected to the upper cover by a bolt in a sealing manner, the waterproof steering gear 21 is respectively connected to the hatch door opening mechanism and the gas cylinder opening mechanism on both sides through the bevel gear transmission mechanism 29. A rescue capsule is symmetrically hinged to both sides of the base 28, and the rescue capsule is provided with the hatch door opening mechanism. The gas cylinder 33 and a folded lifesaving airbag 31 are respectively arranged in the rescue capsule in a sealing manner. A gas outlet pipe of the gas cylinder 33 is respectively connected to a gas inlet nozzle 32 of the rescue capsule and an ejector pin 34 by a tee. The gas inlet nozzle 32 is used as a one-way gas inlet valve, and the ejector pin 34 can open a gas outlet channel communicating between the gas cylinder 33 and the lifesaving airbag 31 through the gas cylinder opening mechanism. In this embodiment, the lifesaving airbag 31 is added for underwater rescue and other scenarios, which expands the actual application scenario of the bionic robot fish to a certain extent.

As an alternative scheme, the hatch door opening mechanism includes a transmission gear 35 and a wobble gear 36, the wobble gear 36 is fixedly connected to a hatch door 30. The transmission gear 35 and one bevel gear of the bevel gear transmission mechanism 29 are coaxially arranged, the wobble gear 36 is fixedly connected to a hinge shaft of the hatch door 30, and the transmission gear 35 is meshed with the wobble gear 36. The gas cylinder opening mechanism includes a spur gear 37, and a rack 38. The spur gear 37 and the wobble gear 36 are coaxially arranged, the rack 38 is meshed with the spur gear 37, and the rack 38 is slidably arranged in a sliding chute of the upper cover to achieve the linear reciprocation of the rack 38. The rack 38 is provided with a bump 39 with an inclination angle, and the bump 39 can extrude the ejector pin 34 to move axially to open the gas outlet channel. The outside of the gas cylinder 33 is connected to a protective sleeve 40 through threads, and the protective sleeve 40 includes a head protective sleeve and a tail protective sleeve which are spliced into a whole, and the head protective sleeve is provided with a limit hole for the ejector pin 34. The gas cylinder 33 employs a carbon dioxide compressed gas cylinder, a fixed connection between the gas cylinder 33 and the protective sleeve 40 of the gas cylinder 33 can be achieved by threads. The limit hole is a stepped hole with small outside and large inside. An outer end of the ejector pin 34 is provided with a shaft shoulder in fit with the stepped hole, and an inner tip of the ejector pin is similar to a needle, and thus an axial movement of the ejector pin 34 of the gas cylinder 33 can be limited, and the gas outlet pipe from the gas cylinder 33 can be placed. The protective sleeve 40 is fixed into the base 28 in a snap-fit manner. The opening device of the lifesaving airbag 31 is actuated by one steering gear, and two side doors of a lifesaving device can be opened and closed at the same time, and the lifesaving device can be recycled all the time by replacing the carbon dioxide compressed gas cylinder and the lifesaving airbag 31. In this embodiment, when the hatch door 30 is unopened, the relative positions of the ejector pin 34 and the rack 38 are unchanged. When the opening of the hatch door 30, the rack 38 and the bump are driven to translate, the bump 39 pushes the ejector pin 34 of the gas cylinder 33 to move inwards in an axial direction, thus puncturing a sealing thin film of the carbon dioxide compressed gas cylinder. Afterwards, the compressed gas flows into the folded lifesaving airbag along an exhaust pipeline from another branch of the tee, such that the lifesaving airbag 31 can be filled with the gas rapidly within short time and thrown out of the hatch door 30, thus providing enough buoyancy for the victims in the water and achieving rescue in the water.

Preferably, the buoyancy adjusting mechanism 6 includes a waterproof housing 41, a waterproof steering gear 21, a variable diameter mechanism, and multiple profiling push plates 42. The profiling push plates 42 can be spliced into U-shaped fish belly part. The waterproof housing 41 is arranged inside the U-shaped fish belly part. The waterproof steering gear 21 and the variable diameter mechanism are arranged in the waterproof housing 41. The waterproof steering gear 21 is connected to the variable diameter mechanism. The waterproof steering gear 21 is connected to the profiling push plates 42 through the variable diameter mechanism. The profiling push plates 42 are wrapped with the bionic fish skin 15, and the profiling push plates 42 can extend outwards and retract inwards through the variable diameter mechanism. The variable diameter mechanism can better simulate the action mechanism of a swim bladder through a volume change method, that is, the bionic fish skin 15 (sealant rubber skin) is sleeved outside the device, and the rubber skin expands or retracts through the motion of the variable diameter mechanism, so as to simulate the real motion of the swim bladder. Although the rubber skin will be affected by the water pressure when the bionic fish reaches a certain depth, the influence of the water pressure on the spreading of the rubber skin can be reduced when an internal mechanism is driven by a high-torque motor. Secondly, the timeliness and efficiency of this method are much higher than those of the water storage method and the pectoral fin 23 control method.

As an alternative scheme, the variable diameter mechanism in this embodiment includes a variable diameter rotating disc 44, and a gear transmission mechanism 12. The waterproof steering gear 21 is connected to the variable diameter rotating disc 44 by the gear transmission mechanism 12, and each profiling push plate 42 is provided with a support rod 43. A middle part of the variable diameter rotating disc 44 is provided with multiple arc waist-shaped holes 45, inner ends of the waist-shaped holes 45 are located in the same smaller radius concentric circle, outer ends of the waist-shaped holes 45 are located in the same larger radius concentric circle, and one waist-shaped hole 45 corresponds to one support rod 43. A tail end of each support rod 43 is slidably arranged in the corresponding waist-shaped hole 45 through a pin shaft 46. The waterproof housing 41 is provided with a guide groove, and the support rod 43 movably penetrates through the guide groove to facilitate the support rod 43 to slide along the guide groove. In this embodiment, the support rod 43 of the profiling push plate 42 is circumferentially limited by the guide groove, and through the forward rotation or reverse rotation of the motor, the support rod 43 is driven by the waist-shaped hole 45 of the variable diameter rotating disc 44 to translate outwards or inwards along the guide groove, and then the profiling push plate 42 is driven to expand outward or retract inward to change the volume of the robot fish, such that the real motion of the swim bladder can be simulated, the relationship between the buoyancy and gravity of the bionic robot fish is then changed (fine-tuned), thus achieving the functions of floating and diving of the bionic robot fish. According to such a method, the action mechanism of the swim bladder can be well simulated, and high timeliness and efficiency are achieved.

In this embodiment, rigid materials such as housings, fish bodies and skeletons in the fish body skeleton 1 and the fish head skeleton 2 as well as the pectoral fins 23 are printed with 3D printing materials with density close to that of water, which may employ the WeNext R4600 resin of Shenzhen WeNext Technology Co., Ltd. Rigid transmission elements, such as a gear transmission mechanism, a transmission shaft and a shaft key and flange 25, are manufactured by numerical control machining. In order to reduce the friction between the gear transmission shaft and a casing, bearings 27, preferably angular contact ball bearings, are used on each transmission shaft in this embodiment.

On the basis of studying the swimming characteristics of fish, a novel bionic robot fish based on a propulsion mode of the Carangidae is provided. The underactuated pull-wire type motor is used to drive the pull wires 14 on both sides to achieve the fluctuation of fishtail, which not only reduces the number of motors and greatly simplifies the control difficulty, but also can simulate the swimming of fish more realistically, thus achieving higher propulsion efficiency and flexibility. Different from the traditional underwater robots such as ROV, AUV and bionic robot fish with multi-joint motors in series, the bionic robot fish in this embodiment can highly fit the body fluctuation of fish, and meanwhile, the number of motors and the power consumption of the system are greatly reduced. In this embodiment, the ability of the bionic robot fish to identify objects is increased, and the pictures of the submerged structure and the victims in the water collected are trained in the early stage using the YOLOv8-based network model, such that the robot fish has high accuracy in identifying the defects of the submerged structure and identifying the victims, and gives high recognition ability for real-time feedback of the defects of the submerged structure and autonomous and rapid underwater rescue action of the bionic robot fish.

In this specification, specific embodiments aim to illustrate the principle and implementation of the present disclosure. The explanation of the above embodiments is only used to help understand the method and its core idea of the present disclosure. According to the idea of the present disclosure, there will be some changes in the specific implementation and application scope for those skilled in the art. To sum up, the contents of this specification should not be construed as limiting the present disclosure.

What is claimed is:

1. A bionic rescue robot fish, comprising:
a fish body skeleton, a fish head skeleton, the fish body skeleton being movably connected to the fish head skeleton;
a fishtail swing mechanism;
a pectoral fin swing mechanism;
a rescue mechanism configured to release a lifesaving airbag;
a buoyancy adjusting mechanism configured to change a volume of a fish belly part of the bionic rescue fish, wherein the fishtail swing mechanism, the pectoral fin swing mechanism, the rescue mechanism and the buoyancy adjusting mechanism are arranged on the fish head skeleton and each are in communication with a control unit; and
bionic fish skin is attached to surfaces of the fish body skeleton and the fish head skeleton in a sealing manner.

2. The bionic rescue robot fish according to claim 1, wherein the fish body skeleton comprises a plurality of profiling support pieces, where outer contour dimensions of the plurality of profiling support pieces are designed according to an overall dimension of fish, and gradually increase along a direction from a tail of the bionic rescue robot fish to a head of the bionic rescue robot fish, the plurality of profiling support pieces are elliptical and lower parts of the plurality of profiling support pieces are respectively provided with counterweights, a shape of each of the counterweights is symmetrical about a long axis of a corresponding one of the plurality of profiling support pieces, and a center of gravity of the counterweight is adjacent to a middle part of the fish body;
one or a pair of hinge lugs are arranged at a middle part of each of the plurality of profiling support pieces, and adjacent profiling support pieces of the plurality of profiling support pieces are hinged with a pin shaft through the hinge lugs;
a flexible tail fin is connected to a smallest one of the plurality of profiling support pieces, a biggest one of the plurality of profiling support pieces is hinged with the hinge lugs on the fish head skeleton, and the bionic fish skin is of a bellow structure and is attached to the smallest one of the plurality of profiling support pieces and an outside of an end of the fish head skeleton in a sealing manner, so as to form a bionic fish body; and
a resilient sheet is fixedly connected between the adjacent profiling support pieces.

3. The bionic rescue robot fish according to claim 2, wherein the fishtail swing mechanism comprises:
a stepping motor,
a gear transmission mechanism connected to the stepping motor,
pull wires and
two pull wire drums connected to a rotating shaft of the gear transmission mechanism, and are symmetrically arranged up and down in a manner perpendicular to the flexible tail fin, both sides of each of the two pull wire drums are fixedly connected to corresponding positions of the smallest one of the plurality of profiling support pieces by the pull wires.

4. The bionic rescue robot fish according to claim 1, further comprising:
a transparent observation window arranged on an upper part of the fish head skeleton in a sealing manner, the transparent observation window comprises a pressure-resistant glass cover, and a sealing ring is arranged between the observation window and the fish head skeleton
a color camera connected to a support inside the observation window, wherein the fish head skeleton is provided with a sealing compartment and a battery compartment such that the control unit is arranged in the sealing compartment, and a storage battery is arranged in the battery compartment;
a power switch provided at a top of the fish head skeleton; and
an ultrasonic sensor provided at each of both sides and a front end of the fish head skeleton.

5. The bionic rescue robot fish according to claim 1, wherein the pectoral fin swing mechanism is symmetrically arranged in the fish head skeleton, and comprises:
two waterproof steering gears,
two gear transmission mechanisms each having a rotating shaft, each of the two waterproof steering gears being connected to a corresponding one of the two gear transmission mechanisms, and
pectoral fins, where the rotating shaft of one gear of each of the two gear transmission mechanisms is connected to a corresponding one of the pectoral fins by a coupling, the coupling is rotatably arranged in a through groove of a special-shaped waterproof block, and an inside of the waterproof block is connected to a flange on the rotating shaft of the gear transmission mechanism through a double-lip sealing ring, the two waterproof steering gears being configured to make the pectoral fins swing up and down by 30°-50° with a horizontal plane as a middle plane.

6. The bionic rescue robot fish according to claim 1, wherein the fish belly part of the fish head skeleton is provided with a U-shaped groove, and the rescue mechanism and the buoyancy adjusting mechanism are arranged in the U-shaped groove; the bionic fish skin is attached to two side walls of the buoyancy adjusting mechanism, two side walls of the U-shaped groove and a bottom of the rescue mechanism in a sealing manner; the bionic fish skin is resilient, and the buoyancy adjusting mechanism is configured to change a volume of the bionic fish skin.

7. The bionic rescue robot fish according to claim 1, wherein a shape of the rescue mechanism is U-shaped, and the rescue mechanism comprises
a base,
an upper cover, the base being connected to the upper cover by a bolt in a sealing manner;
a waterproof steering gear,
a bevel gear transmission mechanism,
hatch door opening mechanisms,
gas cylinder opening mechanisms, the waterproof steering gear is respectively connected to the hatch door opening mechanisms and the gas cylinder opening mechanisms on both sides of the rescue mechanism through the bevel gear transmission mechanism;
lifesaving airbags and gas cylinders; and
rescue capsules symmetrically hinged to both sides of the base, and the hatch door opening mechanism are respectively provided on the rescue capsules;
the lifesaving airbags are folded and respectively arranged in the rescue capsules in a sealing manner, and the gas cylinders are respectively arranged in the rescue capsules in a sealing manner;
a gas outlet pipe of each of the gas cylinders is connected to a gas inlet nozzle of a corresponding one of the rescue capsules and an ejector pin by a tee, and the ejector pin is configured to open a gas outlet channel communicating between a corresponding one of the gas cylinders and a corresponding one of the lifesaving airbags through a corresponding one of the gas cylinder opening mechanisms.

8. The bionic rescue robot fish according to claim 7, wherein each of the hatch door opening mechanisms comprises
a transmission gear, the transmission gear and one bevel gear of the bevel gear transmission mechanism are coaxially arranged; and
a wobble gear being fixedly connected to a hinge shaft of the hatch door, the transmission gear being meshed with the wobble gear;
wherein each of the gas cylinder opening mechanisms comprises a spur gear coaxially arranged with the wobble gear, and a rack meshed with the spur gear, the rack being slidably arranged in a sliding chute of the upper cover and provided with a bump with an inclination angle, the bump being configured to extrude the ejector pin to move axially to open the gas outlet channel;
a protective sleeve is connected to an outside of the gas cylinder through threads, and the protective sleeve comprises a head protective sleeve and a tail protective sleeve which are spliced into a whole, the head protective sleeve being provided with a limit hole for the ejector pin.

9. The bionic rescue robot fish according to claim 1, wherein the buoyancy adjusting mechanism comprises
a waterproof housing arranged inside the fish belly part;
a waterproof steering gear arranged in the waterproof housing;
a variable diameter mechanism arranged in the waterproof housing and connected to the waterproof steering gear; and
a plurality of profiling push plates wrapped with the bionic fish skin and connected to the waterproof steering great thorough the variable diameter mechanism, wherein the plurality of profiling push plates are able to be spliced into the fish belly part with an U shape and are configured to extend outwards and retract inwards through the variable diameter mechanism, the waterproof steering gear is connected to the plurality of profiling push plates through the variable diameter mechanism.

10. The bionic rescue robot fish according to claim 9, wherein the variable diameter mechanism comprises a variable diameter rotating disc and a gear transmission mechanism, the waterproof steering gear of the buoyancy adjusting mechanism is connected to the variable diameter rotating disc by the gear transmission mechanism, and each of the plurality of profiling push plates is provided with a support rod;
wherein a middle part of the variable diameter rotating disc is provided with a plurality of arc waist-shaped holes, inner ends of the plurality of waist-shaped holes are located in a same smaller radius concentric circle, outer ends of the plurality of waist-shaped holes are located in a same larger radius concentric circle, and one waist-shaped holes corresponds to one support rod;
a tail end of each support rod is slidably arranged in a corresponding one of the plurality of waist-shaped holes through a pin shaft, and wherein the waterproof housing is provided with a guide groove, and the support rod movably penetrates through the guide groove.
